(19) United States
(12) Patent Application Publication
(10) Pub. No.: US 2013/0273298 A1
(43) Pub. Date: Oct. 17, 2013

(54) DEFORMABLE SUPPORT

(71) Applicant: Hsin-Hung CHUANG, Jhongli City (TW)

(72) Inventor: Hsin-Hung CHUANG, Jhongli City (TW)

(21) Appl. No.: 13/448,817

(22) Filed: Apr. 17, 2012

(51) Int. Cl. B32B 1/06; B32B 3/06

(52) U.S. Cl. 428/76

(57) ABSTRACT

A deformable support comprises a soft surface and a plurality of backbones which develop an interconnected and separable head-to-tail structure: the soft surface is provided with a decorative appearance and a hollow cavity; a backbone is provided with a convex connection plug and a concave connecting hole at both axial ends. When the connecting hole is filled by and connected to another backbone's connection plug, the backbones are developed to be an interconnected and separable head-to-tail structure by means of the connection plugs and connecting holes and accommodated in the soft surface's cavity in which there is enough space for the backbones movably separated or connected. As such, a deformable support which is flexibly deformed to sustain an object or become an ornament is created due to the soft surface's flexibility and the backbones' supporting capability.

### BACKGROUND OF THE INVENTION

1. Field of the Invention

The present invention relates to a support, especially a deformable support which is taken as an ornament and effective in sustaining an object.

2. Description of the Prior Art

In the 21st century, people living in countries with industry and commerce highly developed are enjoying the unprecedented material life level and most of them who are used to the modern abundant material lives own a variety of paraphernalia, some of which are representative 3C products such as cellphone, tablet personal computer and E-book reader or common personal objects, e.g., cosmetics, stationery, etc.

These various paraphernalia unquestionably enrich modern people's daily lives but bring inconvenience to them, for instance, 3C products such as cellphone, tablet personal computer and E-book reader usually require a specific reading angle by holding each of theses devices at the angle with a support or another similar object. Notwithstanding supports installed on a minority of 3C products, the design of a support is rare in most 3C products or paraphernalia which are still temporarily supported with alternatives found by a user.

Dedicated supporting devices for specific paraphernalia such as supports or protective casings for tablet personal computers and shelves for cellphones have been particularly designed by some manufacturers but usually become burdens of one user who carries these dedicated supports for various objects.

### SUMMARY OF THE INVENTION

In view of supports necessary to paraphernalia, the present disclosure provides a deformable support which is taken as an ornament and effective in sustaining an object.

The present invention of a deformable support comprises: a soft surface which is an elongate component and has a hollow cavity with both ends enclosed; a plurality of backbones, each of which is provided with a connection plug and a connecting hole at both axial ends for the connecting hole filled by and connected to another backbone's connection plug and the backbones developed to be an interconnected and separable head-to-tail structure by means of the connection plugs and the connecting holes; the backbones are accommodated in the cavity of the soft surface in which there is sufficient space prepared for the backbones movably separated or connected.

In a preferred embodiment, the soft surface is selectively manufactured with one material from rubber, silicon, and plastic.

In a preferred embodiment, the connection plug is provided with an appropriate bump on an exterior which matches an interior of the connecting hole in order to couple the connection plug with the connecting hole.

In a preferred embodiment, the deformable support further comprises a decorative cap (or two decorative caps) at the soft surface's one end (or two ends) with a concave portion (or two concave portions) on which a personal belonging can be placed.

In a preferred embodiment, the deformable support further comprises a touch control head which is directly held on or removed from the soft surface's one end and features electric conductivity.

In a preferred embodiment, the deformable support further comprises a chuck which is coupled with the soft surface at one end.

The present invention of a deformable support comprises: a soft surface which is an elongate component and has a hollow cavity with both ends enclosed and a slot axially extending along the soft surface's exterior and being deep enough to link the cavity; a plurality of backbones, each of which is provided with a connection plug and a connecting hole at both axial ends as well as a convex portion on one facet for the connecting hole filled by and connected to another backbone's connection plug and the backbones developed to be an interconnected and separable head-to-tail structure by means of the connection plugs and the connecting holes; the backbones are accommodated in the cavity of the soft surface in which there is enough space for the backbones movably separated or connected and allow their convex portions to be exposed from the slot of the soft surface.

In a preferred embodiment, the deformable support further comprises a decorative cap (or two decorative caps) installed on one end (or two ends) of the soft surface and provided with a concave portion (or two concave portions) on which a personal belonging can be placed.

In a preferred embodiment, the deformable support further comprises a touch control head which is directly held on or removed from the soft surface's one end and features electric conductivity.

In a preferred embodiment, the deformable support further comprises a chuck coupled with the soft surface's one end.

It can be seen from above descriptions that the present invention of a deformable support is provided with a flexible and decorative soft surface which is bent to be a proper shape and depends on supporting force from the backbones in the cavity to sustain an object or further be a portable accessory.

The effects and embodiments for the present invention are described with drawings, as provided below.

### DETAILED DESCRIPTIONS OF THE PREFERRED EMBODIMENTS

Referring to FIG. 1 which illustrates the first embodiment of the present invention of a deformable support comprising a soft surface 10 and a plurality of backbones 20 to form an interconnected and separable head-to-tail structure:

The soft surface 10, which is selectively manufactured with one material from rubber, silicone and plastic, is an elongate hollow component in which a cavity 11 with both ends enclosed is developed: (1) one end of the soft surface 10 is enclosed with a cap liner 101 via adhesion or appropriate machining (FIG. 1); (2) both ends of the soft surface 10, i.e., mouthpiece 102 and mouthpiece 103, are enclosed in a hot extrusion or ultrasonic welding process (FIG. 4 for its cross-section).

Each backbone 20 is provided with a convex connection plug 21 and a concave connecting hole 22 at both ends along the axial direction: the connecting hole 22 of a backbone 20 is embedded into and linked by a connection plug 21a of another backbone 20a for the backbones 20 and 20a developing an interconnected and separable head-to-tail structure by means of the connection plugs 21a and the connecting holes 22; the connection plug 21 as one columnar component has a specific cross-section, e.g., a rectangle (FIG. 1), a circle (FIG. 7), or each of other shapes which are not limited to shapes shown in the embodiment. The backbones 20 can be manufactured with one material harder than the soft surface 10, e.g., rubber or plastic, which provides sufficient bracing force when the soft surface 10 is deformed.

The cavity 11 must prepare sufficient space for the backbones 20 and 20a movably separated or connected, i.e., a total length of all head-to-tail backbones 20 and 20a L1 is less than an axial length of the cavity 11 L2 (FIG. 2); in a preferred embodiment of the present invention, the space in the cavity 11 allows each pair of neighboring backbones 20 and 20a to be separated (FIG. 3 and FIG. 4) and the soft surface 10 to be bent during separation of the pair of backbones 20 and 20a for a personal belonging 50 sustained by a deformable support (FIG. 5) which is used to hold a straight rigid personal belonging, e.g., cellphone, tablet personal computer, digital photo frame, E-book, or rigid tablet product with a certain weight that maintains the deformable support out of shape rather than at its initial elongate shape due to resilient force of the soft surface 10.

Referring to FIG. 5 which illustrates the other embodiment of the present invention of a deformable support comprising a chuck 60 being at one end of the soft surface 10 and used to securely adhere to and sustain a personal belonging 50.

Referring to FIG. 6 which illustrates the further embodiment of the present invention of a deformable support wherein a slot 12 axially extends along an exterior of the soft surface 10 and is deep enough to link the cavity 11. Because each backbone 20 has a convex portion 23 which is developed at one facet and bulges according to its cross-section, the backbones 20 and 20a can be accommodated in the cavity 11 of the soft surface 10 wherein the convex portions 23 are exactly exposed from the slot 12 of the soft surface 10 (FIG. 8) and facilitates coupling or separation of any two neighboring backbones 20 and 20a with force applied on the convex portions 23 by one user (FIG. 9A).

Both the connection plug 21 and the connecting hole 22 which have been properly designed can be securely coupled but separated with force slightly applied wherein the connection plug 21 has a suitably raised appearance matching an interior of the connecting hole 22 for the connection plug 21 and the connecting hole 22 mutually engaged; as shown in a preferred embodiment (FIG. 6), a bump 210 whose shape is either a hemisphere or an alternative shape on an exterior of the connection plug 21 matches a recess 220, which is located on an interior of the connecting hole 22, in order to couple the bump 210 with the recess 220 and keep these two components, the connection plug 21 and the connecting hole 22, securely engaged but separated with force slightly applied. As shown in another preferred embodiment (FIG. 7), a circle-shaped protrudent rib 211 on an exterior of the connection plug 21 matches a groove 221, which is located on an interior of the connecting hole 22 and corresponds to the protrudent rib 211, in order to couple the protrudent rib 211 with the groove 221 and keep these two components, the connection plug 21 and the connecting hole 22, securely engaged but separated with force slightly applied.

In a preferred embodiment, the present invention is provided with a decorative cap 13 (or two decorative caps 13) installed at one end (or two ends) of the soft surface 10. As shown in the embodiment (FIG. 6), the decorative cap 13 mounted at one end of the soft surface 10 can be designed to be various styles such as patterns, cartoon characters or other decorative shapes and provided with a concave portion 131 which is developed on a surface of the decorative cap 13 for supporting any personal belonging, for instance, a rigid personal belonging with a straight appearance such as cellphone by placing and securely fixing the cellphone's lower edge on the concave portion 131 (FIG. 9B); similarly, a decorative cap 13a with a three-dimensional appearance (FIG. 7) is directly applied to effectuating skid-resistant purpose.

As shown in a preferred embodiment (FIG. 10), the present invention also comprises a harness 30 and a collar 31 wherein the harness 30, an annular component, is connected to the collar 31 and the collar 31 is bound to one end of the soft surface 10 for the deformable support carried personally or further taken as a portable accessory by means of the harness 30.

As shown in a preferred embodiment (FIG. 11), the present invention further comprises a touch control head 40 which is installed on one end of the soft surface 10, directly held on or removed from one end of the soft surface 10, and taken as an electrically conductive touch control pen for a tablet touch control device (e.g., a tablet personal computer or touch control cellphone).

Notwithstanding the foregoing, the embodiments disclosed for the present invention do not limit the present invention and any person skilled in the art may change or modify embodiments without departing from the spirit and scope of the present invention. Therefore, the scope to be protected under the patent should refer to claims of the patent specifications.

### BRIEF DESCRIPTIONS OF THE DRAWINGS

FIG. 1 is the schematic illustration for a preferred embodiment of the present invention and illustrates a three-dimensional structure and relations of all components of a deformable support.

FIG. 2 is the cross-section view of FIG. 1 along the cutting plane line II-II.

FIG. 3 is the schematic illustration to use the present invention and illustrates a bent soft surface depends on backbones' supporting force to sustain an object.

FIG. 4 is the cross-section view for a preferred embodiment of the present invention and illustrates a soft surface's both ends are enclosed.

FIG. 5 is the schematic illustration for a preferred embodiment of the present invention and illustrates a chuck at one end of a soft surface.

FIG. 6 is the schematic illustration for a preferred embodiment of the present invention and illustrates a three-dimensional structure and relations of all components of a deformable support.

FIG. 7 is the schematic illustration for a preferred embodiment of the present invention and illustrates a three-dimensional structure and relations of all components of a deformable support.

FIG. 8 is the cross-section view for the embodiment in FIG. 6.

FIG. 9A is the cross-section view for the embodiment in FIG. 6 and illustrates separated backbones.

FIG. 9B is the schematic illustration for the embodiment in FIG. 6 and illustrates a bent soft surface depends on backbones' supporting force to sustain an object.

FIG. 10 is the schematic illustration for a preferred embodiment of the present invention and illustrates a deformable support with a harness and a collar.

FIG. 11 is the schematic illustration for a preferred embodiment of the present invention and illustrates a deformable support with a touch control head.

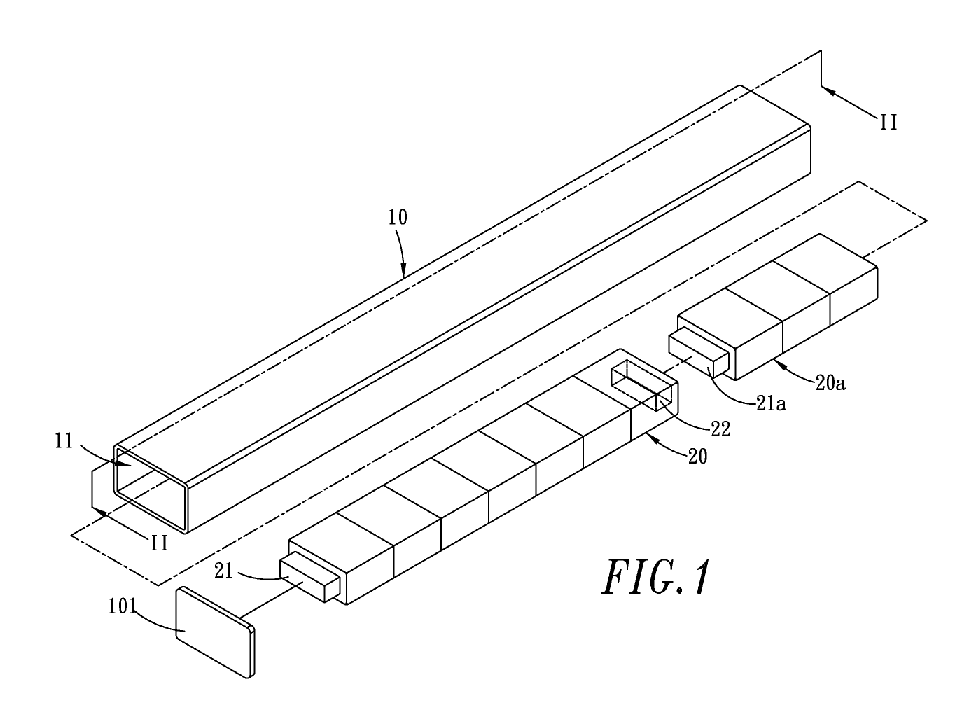

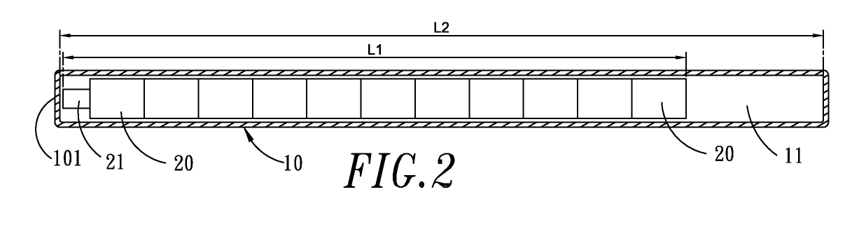

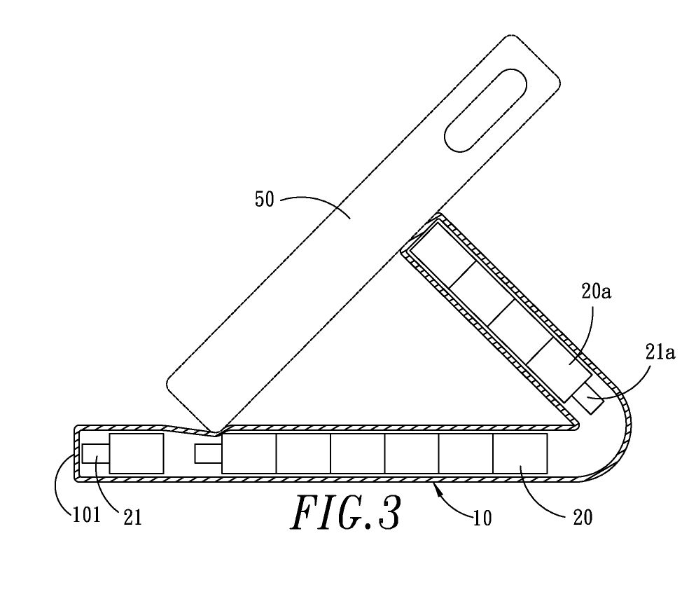

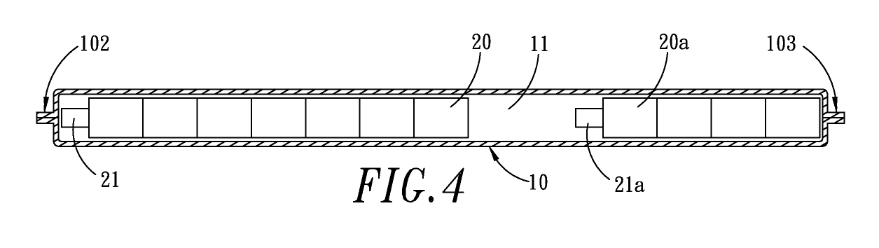

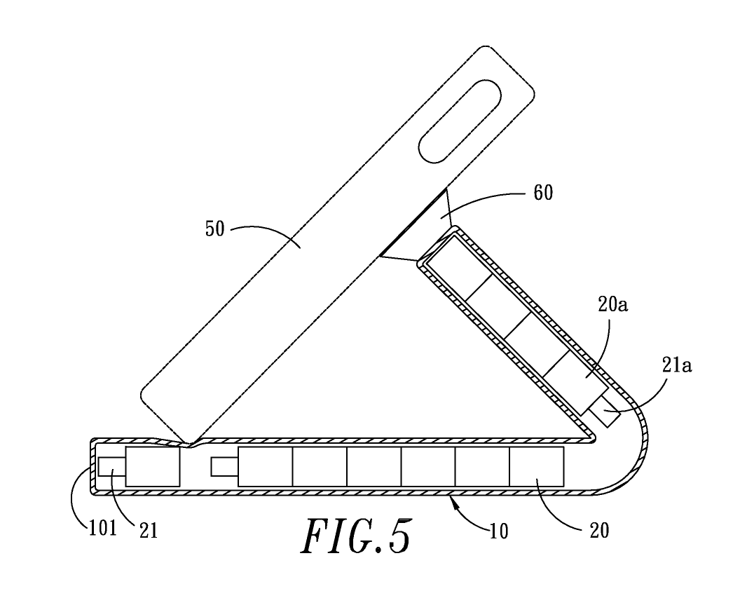

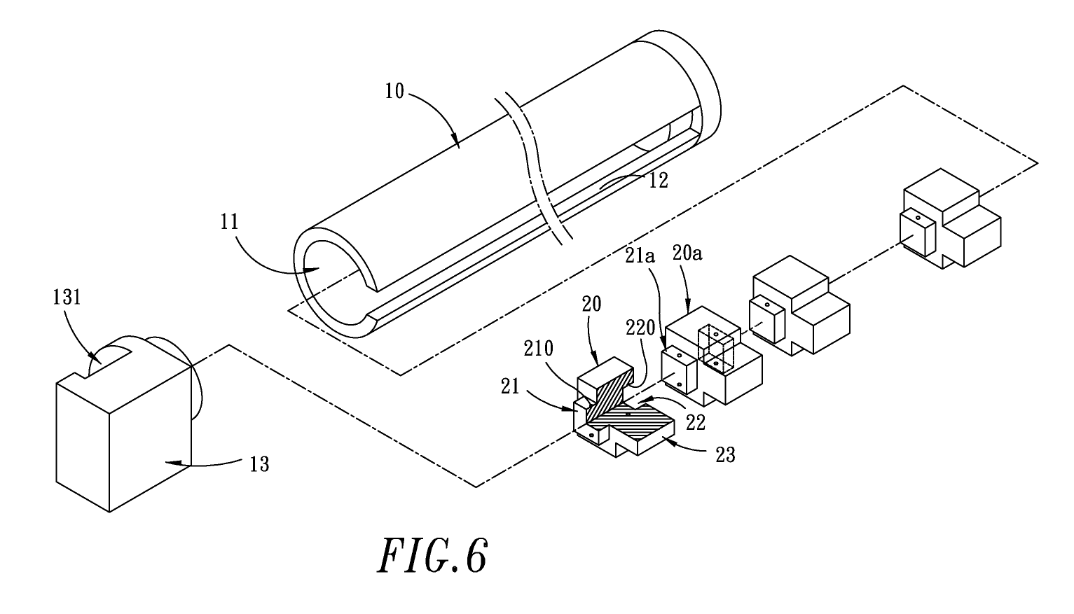

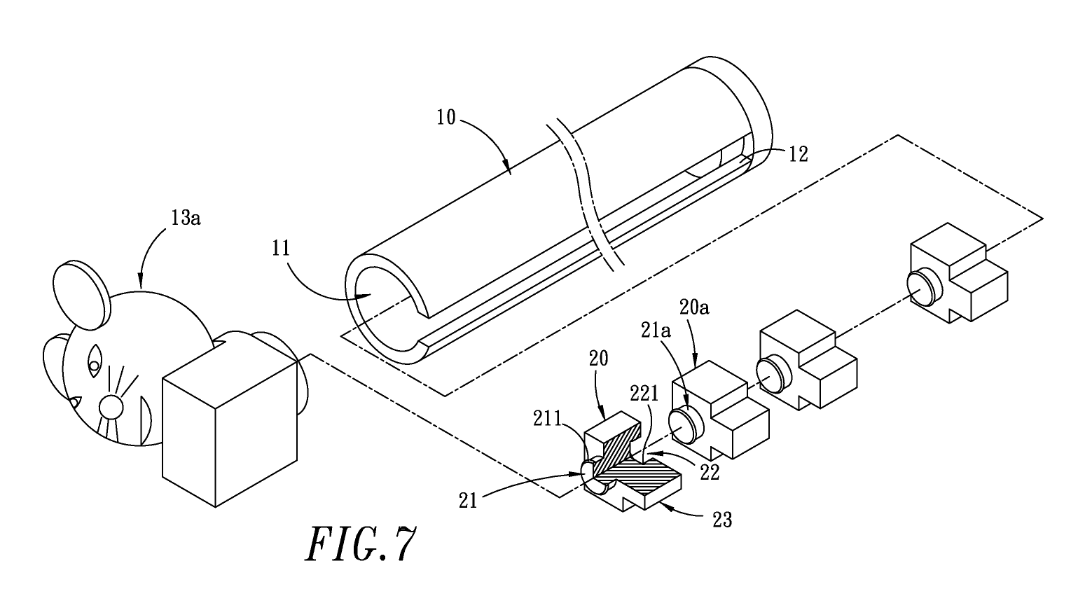

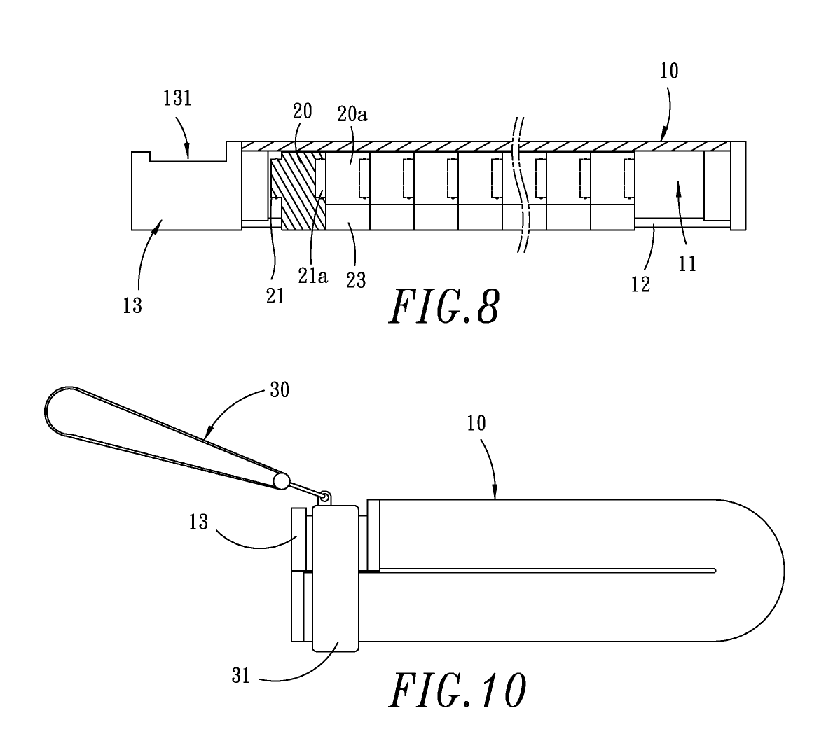

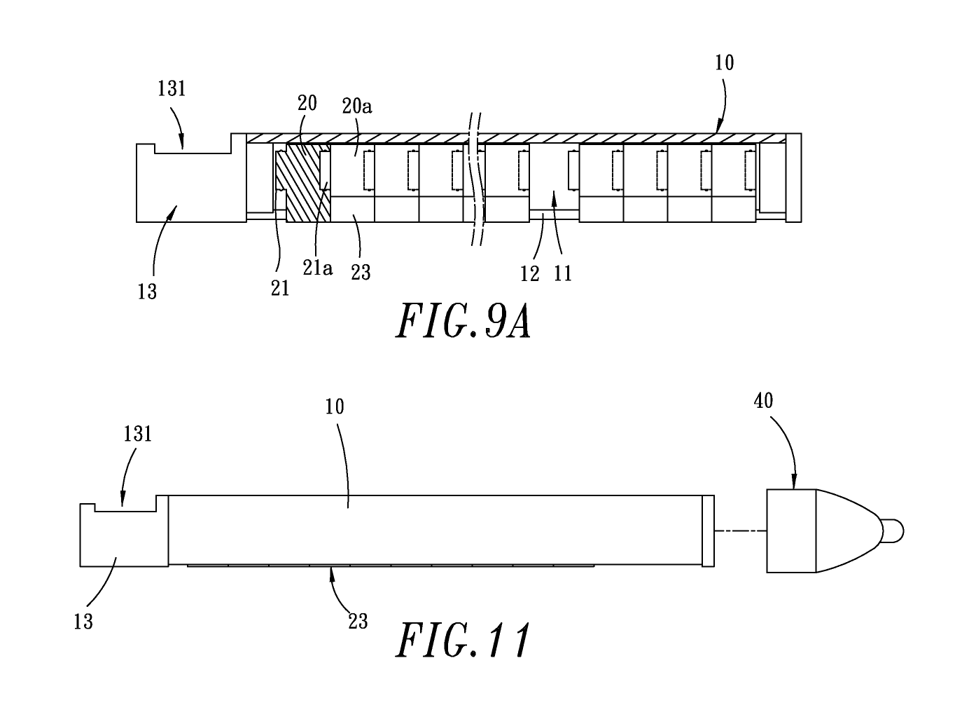

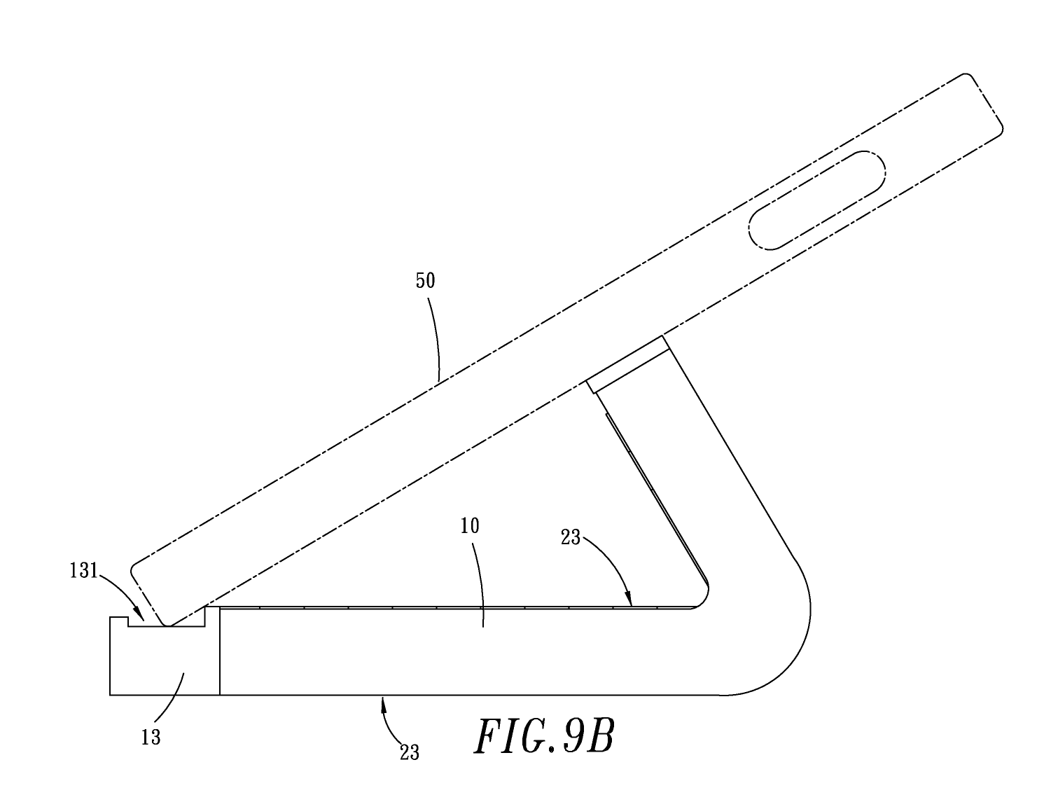

What is claimed is:

1. A deformable support, comprising:
A soft surface, which is an elongate component, comprising a hollow cavity with both ends enclosed;
A plurality of backbones, each of which has a connection plug and a connecting hole at two axial ends, wherein the connecting hole is filled by and connected to another backbone's connection plug and several backbones depend on the connection plugs and the connecting holes to develop an interconnected and separable head-to-tail structure;
The backbones are accommodated in the soft surface's cavity in which there is enough space for the backbones movably separated or connected.

2. The deformable support according to claim 1 wherein the soft surface can be manufactured with one material from rubber, silicone and plastic.

3. The deformable support according to claim 1 wherein the connection plug is provided with a proper bump on an exterior which matches an interior of the connecting hole in order to couple the connection plug with the connecting hole.

4. The deformable support according to claim 1 wherein the deformable support further comprises a decorative cap (or two decorative caps) installed on one end (or two ends) of the soft surface and provided with a concave portion (or two concave portions) on which a personal belonging can be placed.

5. The deformable support according to claim 1 wherein the deformable support further comprises a touch control head which is directly held on or removed from the soft surface's one end and features electric conductivity.

6. The deformable support according to claim 1 wherein the deformable support further comprises a chuck coupled with the soft surface's one end.

7. A deformable support, comprising:
A soft surface, which is an elongate component, comprising (1) a hollow cavity with both ends enclosed and (2) a slot which axially extends along the soft surface's exterior and is deep enough to link the cavity;
A plurality of backbones, each of which has a connection plug and a connecting hole at two axial ends and a convex portion on one facet, wherein the connecting hole is filled by and connected to another backbone's connection plug and several backbones depend on the connection plugs and the connecting holes to develop an interconnected and separable head-to-tail structure;
The backbones are accommodated in the cavity of the soft surface in which there is enough space for the backbones movably separated or connected and allow their convex portions to be exposed from the slot of the soft surface.

8. The deformable support according to claim 7 wherein the deformable support further comprises a decorative cap (or two decorative caps) installed on one end (or two ends) of the soft surface and provided with a concave portion (or two concave portions) on which a personal belonging can be placed.

9. The deformable support according to claim 7 wherein the deformable support further comprises a touch control head which is directly held on or removed from the soft surface's one end and features electric conductivity.

10. The deformable support according to claim 7 wherein the deformable support further comprises a chuck coupled with the soft surface's one end.
